(19) United States
(12) Patent Application Publication
(10) Pub. No.: US 2020/0118148 A1
(43) Pub. Date: Apr. 16, 2020

(54) INTERACTIVE GRAPHICAL USER INTERFACE (GUI)

(71) Applicant: iHeartMedia Management Services, Inc., San Antonio, TX (US)

(72) Inventors: Marwan Shaban, St. Cloud, FL (US); Leslie A. Culpepper, Orlando, FL (US)

(73) Assignee: iHeartMedia Management Services, Inc., San Antonio, TX (US)

(21) Appl. No.: 16/714,964

(22) Filed: Dec. 16, 2019

Related U.S. Application Data
(63) Continuation of application No. 12/683,269, filed on Jan. 6, 2010, now abandoned.

(51) Int. Cl. G06Q 30/02; G06Q 10/06

(52) U.S. Cl. CPC G06Q 30/0201; G06Q 10/067

(57) ABSTRACT

A graphical user interface (GUI) includes a first display area that displays a template including entries corresponding to multiple media stations. Each entry is associated with a unique station identifier. The template also includes multiple attribute fields indicating including location attributes and station attributes associated with content broadcast by the media stations. The first display area accepts a user selection of one or more filter attributes, displays filtered media stations satisfying those attributes, accepts user input selecting a subset of the filtered media stations, and tags the subset of the filtered media stations. A second display area displays a map child window concurrently with the template being displayed in the first display area, and includes a geographic map having a plurality of markers showing physical locations of tagged media stations. A user selects a region on the map, and in response the first display area highlights corresponding media stations displayed in the template.

### CROSS REFERENCE TO RELATED PATENTS

The present U.S. Utility patent application claims priority pursuant to 35 U.S.C. § 120 as a continuation of U.S. Utility application Ser. No. 12/683,269 entitled “MAP-ASSISTED RADIO RATINGS ANALYSIS,” filed Jan. 6, 2010, which is hereby incorporated herein by reference in its entirety and made part of the present U.S. Utility patent application for all purposes.

### BACKGROUND

### 1. Technical Field

The present invention generally relates to graphical user interfaces (GUIs), and more particularly to GUIs with interactive windows.

### 2. Description of Related Art

Advertising and marketing groups depend on information (usually of a statistical nature) to make sound decisions about when, where, and how to advertise. Business managers, executives, and directors also depend heavily on information regarding their company, competitors, and markets in order to make management decisions. There are several sources through which those interested can access advertising-related statistics for radio stations. These sources often gather data for different radio stations with the intention of marketing the information to radio broadcasters, radio networks, cable companies, advertisers, advertising agencies, etc.

There are several standard types of statistics for researching radio stations, including, but not limited to, AQH (or AQHP), Cume, and primary demographic. AQH stands for Average Quarter Hour (AQHP is Average Quarter Hour Persons), and refers to the average number of people listening to a radio station for at least five minutes in any quarter hour of a radio station's schedule. The number of people listening to an entire hour is not necessarily the sum of four quarter hours because of possible duplication. However, some people may listen for more than a single quarter hour. Cume is the total number of different (unique) persons that listen to a radio station within a given daypart. A daypart is a set of times throughout a given week. For example, a daypart could be every weekday (Monday through Friday) from 6:00 am until 10:00 am. If the daypart is 15 minutes there is no difference between AQH and Cume. Primary demographic refers to various categories of consumers (listeners of a given radio station) such as gender or age. Cume rating is the Cume expressed as a percentage of all persons in a specified demographic group.

Arbitron, Inc., is one organization which collects raw radio listener data and generates statistical information similar to the standard statistics mentioned above. It is a media and marketing research firm which primarily serves media companies and advertisers/advertising agencies who carry out ratings analysis based on the statistics. Arbitron selects random samples of the population throughout various areas in the United States, and surveys participants regarding their actual listening times and behaviors. PD Advantage is one system published by Arbitron which itself analyzes ratings trends. It is a software application specifically designed to provide programmers with audience reports and analysis that can help them better understand their data to reach their ratings goals. Programmers can access audience reports via a question-and answer format to develop marketing strategies. PD Advantage also includes information on national format norms, first and second preference stations (P1 and P2), hour-by-hour trending, age trending, tune-in length and core listening trends.

Another source for advertising-related data for radio stations is PrecisionTrak. PrecisionTrak is a web-based program that provides extensive media information about television, cable, radio and newspaper properties along with related entities such as owners, representatives and networks. Data elements for radio stations include primary and secondary demographics, shows and networks.

Taken together, these information sources can give a market researcher a sizable amount of information about radio stations. However, the actual process of obtaining, aggregating, and processing the vast information from a number of different sources is very cumbersome. Obtaining information from many isolated sources can be time consuming. If the process takes too long, the data spoils and marketers cannot perform reliable research or devise effective marketing strategies. The lack of timely and organized information can also cause programmers and executives to be limited in their understanding of their own products, or be ill-informed of trends and not able to respond accordingly.

Even if the information could be timely obtained and organized, it would still be difficult or impossible for the marketer to have a meaningful review of the data due not only to the sheer volume but also due to the fact that it is coming from disparate sources which provide no relationship between the various statistics. It would, therefore, be desirable to devise an improved method of collecting radio station information from multiple sources in a timely manner. It would be further advantageous if the method could present the information in a comprehensive manner which would allow the marketer to build unique marketing strategies for delivering optimum results based on customer needs.

### SUMMARY OF THE INVENTION

The foregoing objects are achieved in a computer-implemented method of analyzing markets for media stations such as radio stations by displaying a template or grid having entries corresponding to the media stations wherein each entry has associated therewith a unique station identifier and multiple fields for different attributes, identifying a subset of the media stations based on a user selection of one or more of the attributes, and displaying a map having location markers corresponding to physical locations of media stations in the identified subset. In one embodiment, the attributes advantageously include multiple station ratings criteria such as Cume and AQHP. The entries in the grid may be sorted for display according to user selection of one or more of the attributes. The subset of the media stations may be identified by filtering the entries based on a selected value for at least one of the attributes. In a preferred implementation the invention further automatically highlights entries in the grid responsive to user selection of corresponding station location markers shown in the map. Other windows may be provided by the user interface in addition to the grid and map windows, including a chart window which compares media stations according to a selected attribute, a trend window which shows attribute values for media stations over time, and a station information window for a selected media station.

The above as well as additional objectives, features, and advantages of the present invention will become apparent in the following detailed written description.

### BRIEF DESCRIPTION OF THE SEVERAL VIEWS OF THE DRAWING(S)

The present invention may be better understood, and its numerous objects, features, and advantages made apparent to those skilled in the art by referencing the accompanying drawings.

FIG. 1 is a block diagram of a computer system programmed to carry out media station market analysis in accordance with one implementation of the present invention;

FIG. 2 is a pictorial representation of a system used in accordance with one embodiment of the present invention for data aggregation and dissemination;

FIG. 3 is a screenshot of a user interface for a market analysis software application constructed in accordance with one implementation of the present invention, the user interface having a grid window containing a layout of different station entries, i.e., radio stations;

FIG. 4 is another screenshot of the user interface of FIG. 3, the user interface further having a map window with highlighted locations corresponding to entries selected in the grid window;

FIG. 5 is yet another screenshot of the user interface of FIG. 3, wherein a subset of the entries in the grid and map windows are selected using a filter dialog box having different radio station formats;

FIG. 6 is still another screenshot of the user interface of FIG. 3, further having a chart window for viewing statistical values such as Cume;

FIG. 7 is even another screenshot of the user interface of FIG. 3, further having a trend window for analyzing statistical values such as AQHP; and

FIG. 8 is a screenshot showing a station information window which may additionally be included in the user interface of FIG. 3.

The use of the same reference symbols in different drawings indicates similar or identical items.

### DETAILED DESCRIPTION OF THE INVENTION

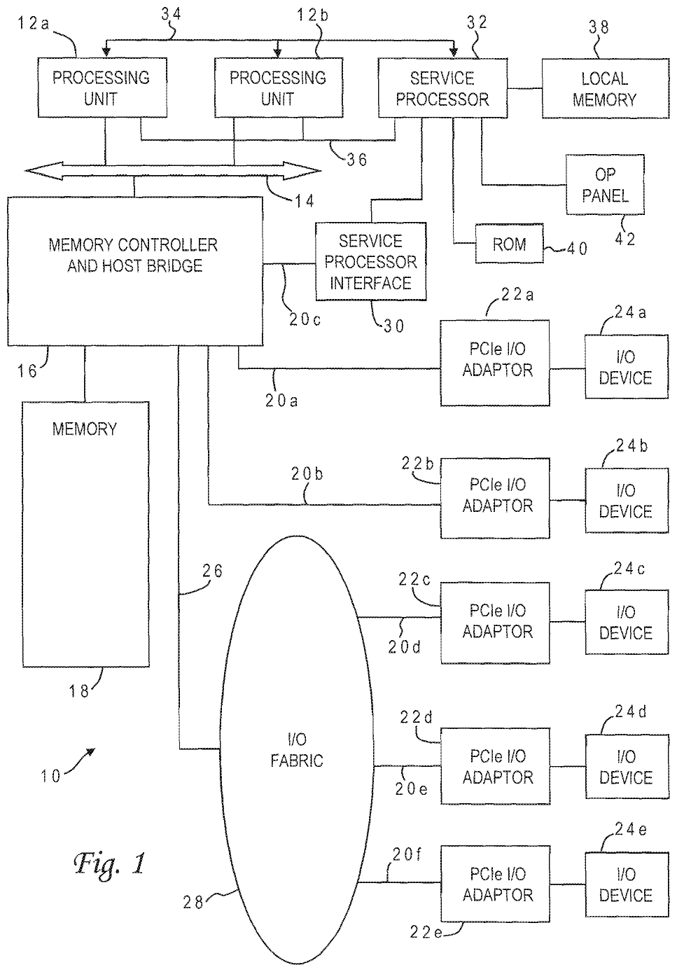

With reference now to the figures, and in particular with reference to FIG. 1, there is depicted one embodiment 10 of a computer system in which the present invention may be implemented to carry out the analysis of radio station markets. Computer system 10 is a symmetric multiprocessor (SMP) system having a plurality of processors 12a, 12b connected to a system bus 14. System bus 14 is further connected to a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component, but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing, then computer system 10 is allowed to proceed. Executable code is loaded into memory 18 and service processor 32 releases host processors 12a, 12b for execution of the program code, e.g., an operating system (OS) which is used to launch applications and in particular the radio station market analysis application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

While the illustrative implementation provides program instructions embodying the present invention on a disk drive of computer system 10, those skilled in the art will appreciate that the invention can be embodied in a program product utilizing other computer-readable storage media. The program instructions may be written in the C++ programming language for a Windows 7 environment or in other programming languages suitable for other operating system platforms. Computer system 10 carries out program instructions for radio station market analysis that implement novel presentation techniques to manage extensive amounts of station-related information. Accordingly, a program embodying the invention may include conventional aspects of various statistical tools, and these details will become apparent to those skilled in the art upon reference to this disclosure.

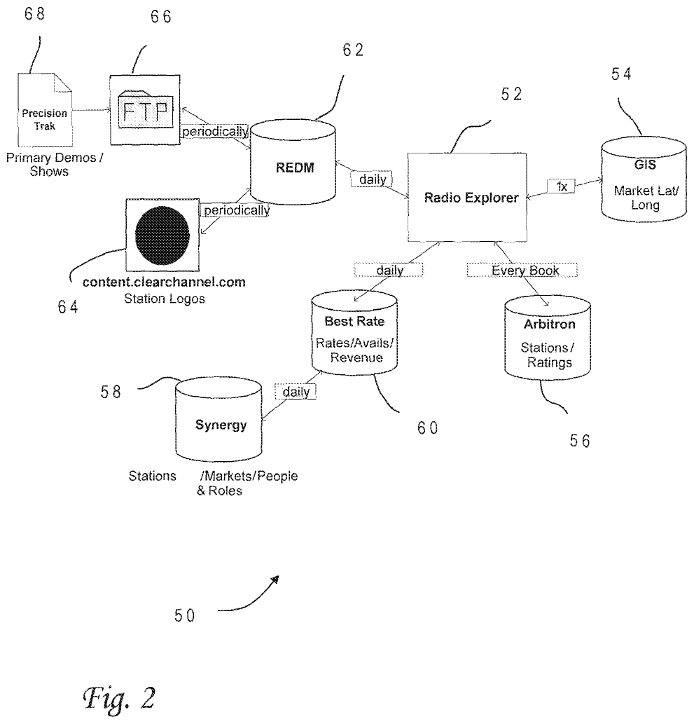

Computer system 10 is programmed to execute a radio explorer application which is part of a market analysis system 50 as illustrated in FIG. 2. The radio explorer application 52 can communicate with other parts of market analysis system 50 for the purpose of collecting, aggregating, and disseminating radio station statistics, data, and information. In this exemplary embodiment, radio explorer application 52 receives geographic data (latitude and longitude of various radio stations) from geographic information system 54, which is updated only once every update cycle. Arbitron 56 provides station ratings and other relevant data, which is updated multiple times per year, e.g., for its Spring book, Summer book, Fall book, and Winter book (Arbitron also provides monthly books). Best Rate information system 60 provides rates to inventory using a rate/yield management model for specific radio stations owned or affiliated with the operator of radio explorer application 52. Best Rate information system 60 can obtain related information for such radio stations, markets, people and roles from Synergy data source 58. Synergy data source may in turn gather information from public or private sources such as PeopleSoft. Best Rate 60 is updated daily (nightly) with data from Synergy 58, and Radio explorer application 52 receives daily updates from Best Rate 60. REDM 62 (Radio Enterprise Data Mart) is a system which extracts, aggregates and archives enterprise data to be used by various applications. This data includes, but is not limited to, radio station inventories and revenues. One location from which REDM 62 extracts data can be an Internet-based server or website 64, which provides ancillary data on radio station logos that is updated periodically. Another information source for REDM 62 can be PrecisionTrak 68, which provides various radio and television station information including primary and secondary demographic, shows, and network. REDM 62 receives periodic updates from PrecisionTrak 68 via File Transfer Protocol 66 over the Internet. Other formats/protocols may be used for the interfaces between the components of market analysis system 50 as will become apparent to those skilled in the art. While the foregoing input sources for radio explorer application 52 are particularly advantageous for conveying succinct information to the market analyst, those skilled in the art will appreciate that various sources with different types of information may be used for data aggregation and presentation, such as Nielsen.

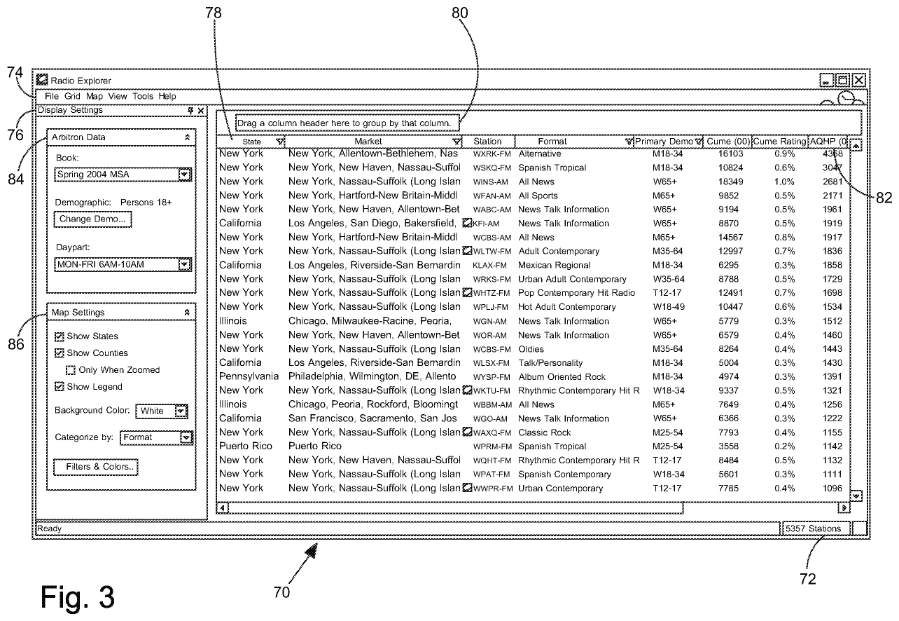

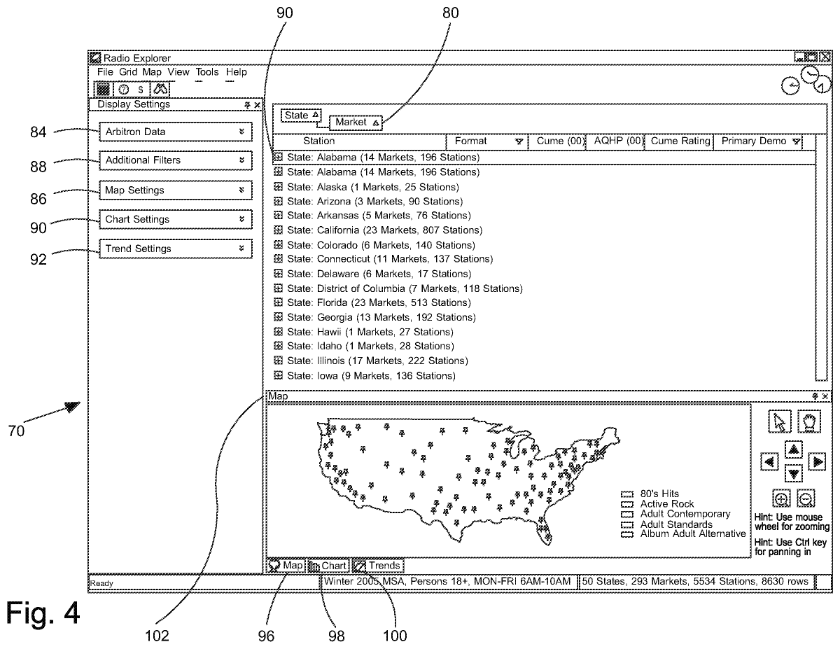

The radio explorer application 52 executed by computer system 10 may provide a variety of user interfaces according to different embodiments of the invention. These user interfaces appear on the display device of computer system 10 (an I/O device 24). FIG. 3 depicts one embodiment of a user interface 70 displaying a radio explorer parent window 72. Radio explorer parent window 72 contains menu items 74, display settings child window 76, and grid child window 78. Display settings child window 76 contains multiple buttons or tabs for expanding different setting categories including Arbitron data tab 84, map settings tab 86, additional filters tab 88, chart settings tab 90, and trend settings tab 92, all of which are displayed in FIG. 4 in minimized form. Only Arbitron data tab 84 and map settings tab 86 are shown in FIG. 3, both in maximized form. Arbitron data tab 84 may for example allow selection of different books, demographics, and dayparts. Map settings tab 86 apply to the map which is described in conjunction with FIG. 4 below, and may for example allow display of state or county boundaries and a legend, selection of a background color, and categorization of stations based on a selected attribute.

Grid child window 78 contains a layout of different station entries, e.g., radio stations, with their attributes listed in the different rows of grid child window 78. The stations and attributes can be displayed according to another type of template besides a grid. The station name (or other unique station identifier) and other attributes are arranged in respective attribute fields or columns 82 and can be used to rank the stations. A user can then sort the list of stations by any attribute made available by the program designer, such as a radio station's state of operation, Cume, Cume rating, primary demographic, geographic market, format, AQHP, or other ratings criteria. Also located in grid child window 78 is grouping preferences 80. Grouping preferences 80 gives a user the ability to organize radio stations hierarchically based on a specified attribute or set of attributes.

One illustration of how these stations can be organized into hierarchical groups using grouping preferences 86 is shown in FIG. 4. In this illustrative example of user interface 70, computer system 10 accepts a user selection for grouping preferences 80′ to be “state” as the primary grouping and “market” as the secondary grouping. The corresponding attribute column 82 for each of the attributes listed in grouping preferences 80′ is not present since the radio stations are now being grouped based on these attributes. Each row in grid child window 78 is now a single group of stations, where the rule for grouping stations has been specified by the primary grouping attribute (in this case, the state in which the radio station is located). A single station group 94 can be expanded by pressing the plus sign button for that group. When a given station group 94 is expanded, if the current grouping is the lowest order grouping then the stations grouped in station group 94 will be listed under station group 94. If instead the current grouping is not the lowest order grouping, then a list of station groups will be displayed under station group 94 with a grouping scheme that depends upon the next lowest order grouping. All of the stations within these smaller groups are also located within the original station group 94 being expanded (in other words, the groups are hierarchically organized). The plus sign button will change to a minus sign button to indicate that the specific station group 94 has been expanded.

Also shown in FIG. 4 is map child window 102 which can display the geographic location of stations tagged in grid child window 78 in response to the user selection using location markers. In this implementation map child window 102 shows a map of the continental United States with radio station locations indicated by dots which are color-coded based on the type of station (80's Hits, Active Rock, Adult Contemporary, etc.). Map child window 102 can be displayed by clicking (using a graphical pointing device) on the map display tab 96, which is located next to chart display tab 98 and trends display tab 100. One way to display a single radio station or set of radio stations in map child window 102 is to select the station(s) in grid child window 78. Radio explorer application 52 can then automatically and responsively display only the selected stations in the map. Conversely, the station(s) can be selected in map child window 102 by clicking on a dot or click-and-dragging to draw a rectangle encompassing one or more station markers, and the corresponding entries in grid child window 78 will automatically and responsively be highlighted. The exact locations may represent for example a market center, an office location, or a broadcast tower location. Map child window 102 may include other features such as zoom and pan controls.

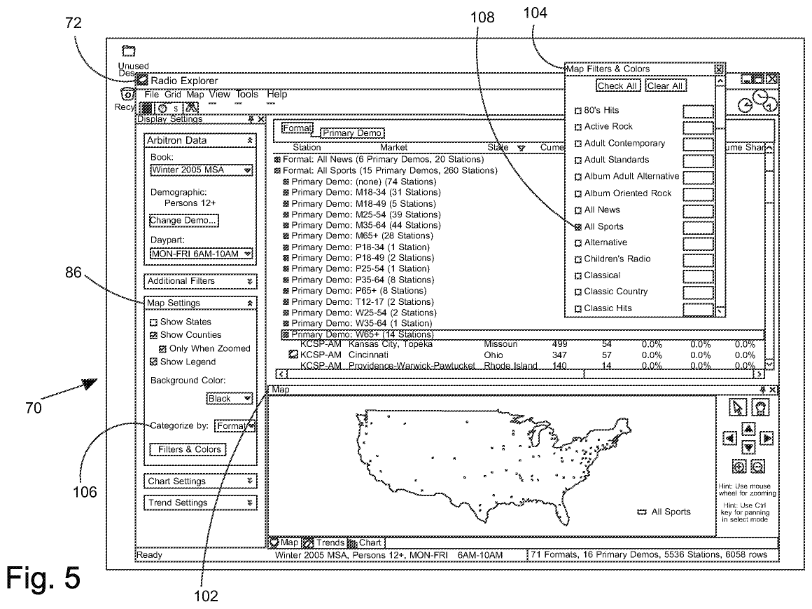

FIG. 5 shows an alternative method for selecting radio stations in grid child window 78 and/or map child window 102 using a filter. Map filters and colors dialog box 104 is opened by clicking the filters and colors button 106 located in map settings tab 86. The various groupings listed in map filters and colors dialog box 104 can be set to select in grid child window 78 and display in map child window 102 a subset of the entries based on a selected value for the current category or attribute, in this example different radio station formats. In FIG. 5 filter check box 108 has been selected for “All Sports” causing map child window 102′ to display only stations which have an all sports format. Grid child window 78 is accordingly set to sort based on format and has expanded the “All Sports” group.

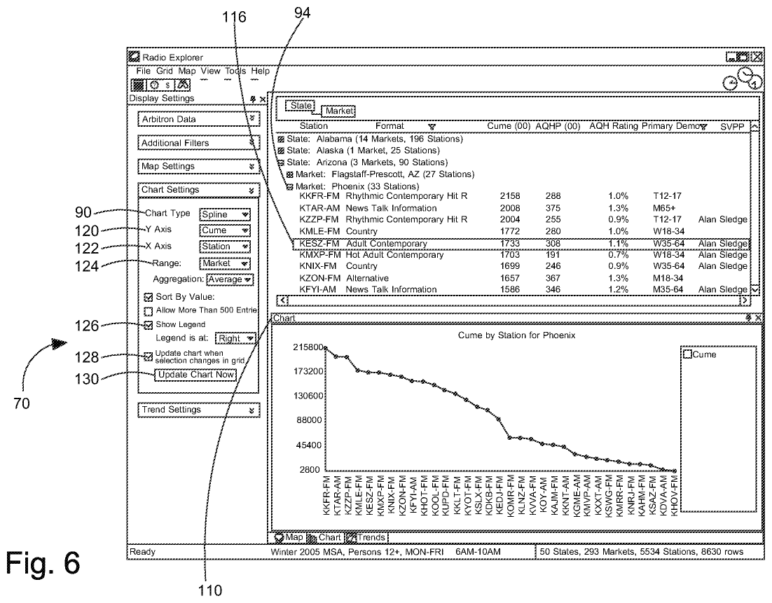

Another way in which user interface 70 can organize and display data is in a chart to compare stations or groupings by various measures. FIG. 6 shows chart child window 110 within radio explorer parent window 72. Chart child window 110 can be displayed by selecting chart display tab 112. The presentation of chart child window 110 depends upon the specific selection of parameters in chart settings tab 90. Adjustable parameters in chart settings tab 90 include chart type parameter 120, y-axis variable 122, x-axis variable 124, range parameter 126, and update choice 128. Altering chart type parameter 120 will change the format of the chart being displayed (spline, pie, bar, or others), while y-axis variable 122 and x-axis variable 124 specify the type of variable (attribute) displayed on each axis. Range parameter 126 specifies a grouping that will determine which data points are displayed, and can take the value of any station attribute. In this embodiment, range parameter 126 has been chosen as “Market,” which means that all data points displayed in chart child window 110 must be grouped within the same market. The market selected in the illustration is the market for Phoenix, Ariz. Since update choice 128 has been selected in chart settings tab 90, whenever a station is selected as the focus in grid child window 78, chart child window 110 will be updated to contain data points which only have the same range parameter grouping as the focused station. In the specific illustration, focused station 116 (“KESZ-FM”) is grouped under the “Phoenix” market grouping (indicated by station group 94′), which dictates that all data points in the updated chart child window 110 must be grouped in the “Phoenix” market grouping. If a station does not share the same range parameter grouping as focused station 116 in grid child window 78, then it will not be shown in chart child window 112. If a user wants to change any of the mentioned parameters in chart settings tab 90, and also have the changes reflected in chart child window 110, the user clicks the update chart now button 130 after altering said parameters.

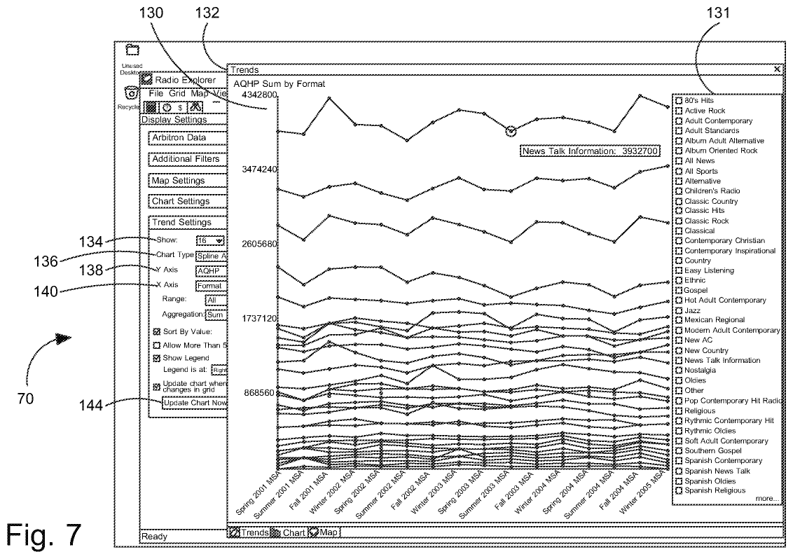

FIG. 7 provides an illustration of how user-interface 70 can further organize and display data using a trend graph to show station or grouping values over time. Trend child window 130 can be displayed by clicking on trends display tab 100. The parameters within trend settings tab 92 specify how the trend graph is rendered in trend child window 130. Adjustable parameters in trend settings tab 92 include show books parameter 134, chart type parameter 136, y-axis variable 138, z-axis variable 140, range parameter 142, and update choice 144. Y-axis variable 138 specifies the type of variable displayed on the vertical axis of trend graph 132 displayed in trend child window 130 (in this illustration, AQHP). The x-axis of trend graph 132 is in units of time, where the units are the seasons of different years. The number of seasons displayed on the x-axis is determined by show book parameter 134. In this example, show book parameter 134 has a value of “16,” and consequently there will be sixteen different seasonal time periods listed on the x-axis. Z-axis variable 140 specifies the grouping scheme for displaying the different trend lines in trend child window 132. In the specific illustration, the different trend lines represent the sum of AQHP for each format group. The various format groups are listed in graph legend 131. The system can thus help identify trends across books and multiple demographic selections. Trend child window 130 has similar functionality as chart child window 110, in that selecting stations for the focus in grid child window 78 can dynamically update both chart child window 110 and trend child window 130. Update chart now button 144 can also be used to update trend child window 130. The various windows described herein can be displayed in any combination, and in various forms such as tiled or overlapping.

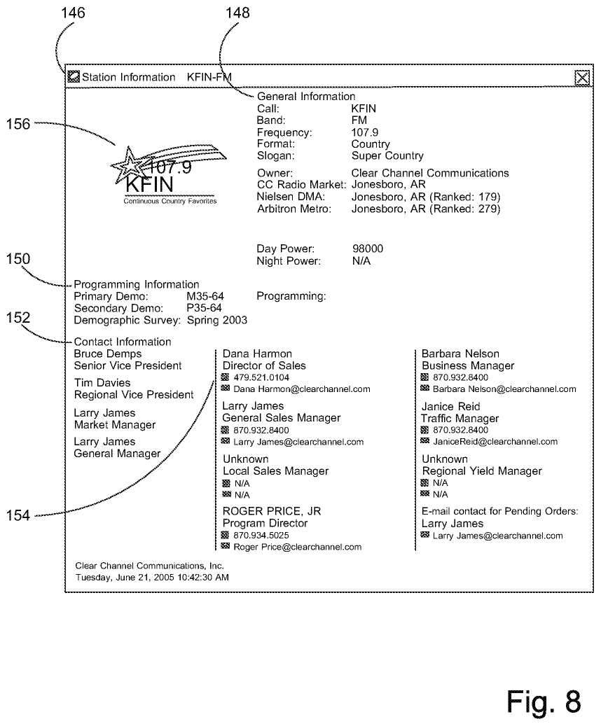

With further reference to FIG. 8, user interface 70 may in some embodiments provide a variety of station information through a station information child window 146. This window can display information pertaining to a specific radio station. A prominent feature in station information child window 146 is the radio station logo 156, which in this example is displayed in the top left area of station information child window 146. Other types of information can be displayed in station information child window 146, including general information 148, programming information 150, contact information 152, and personnel information 154. To obtain information pertaining to the geographic properties of a radio station, a GIS (geographic information system) can be used. A GIS generally provides a user with information pertaining to the geographic properties of a given location, such as the location of a broadcast tower for a given radio station.

The radio station market analysis application of the present invention may utilize additional information about radio properties beyond what is specifically called out in the foregoing implementation. For example, revenue, average minute rates (AMRs), minutes sold, and Miller Kaplan performance, can all be displayed in tabular or graphical form and further allow generation of other graphs or charts such as revenue, rate, Miller Kaplan performance, and/or volume change with ratings change. The additional inclusion of year-over-year growth information can allow a user (e.g., Senior Executive, Buyer, or Program Director) to determine whether certain formats/demographics are performing better or worse over the prior year. The ability provided by the present invention to map such information can reveal regional trends in revenue performance.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. For example, while the foregoing description is provided in the context of terrestrial radio stations, similar information may be aggregated, organized and displayed for other types of stations including but not limited to satellite or internet radio stations, or television stations. Also, the use of terms such as “parent window,” “child window” and “dialog box” are exemplary only, as the particular manner in which the content is displayed may vary considerably in accordance with the preferences of the program designer. It is therefore contemplated that such modifications can be made without departing from the spirit or scope of the present invention as defined in the appended claims.

What is claimed is:

1. A method comprising:
obtaining location information indicating physical locations of a plurality of media stations from a geographic information system (GIS) configured to serve location information associated with the plurality of media stations;
obtaining, from a second source, separate and unrelated to the GIS, information associated with content broadcast by the plurality of media stations;
displaying at least a portion of a template on a display device of a computer system, the template including:
a plurality of entries corresponding to particular media stations of the plurality of media stations, each entry in the template having associated therewith a unique station identifier identifying a media station;
multiple attribute fields indicating attributes of the media station, wherein the multiple attribute fields include:
location attributes associated with the location information; and
station attributes associated with the content broadcast by the plurality of media stations;
accepting a user selection of one or more filter attributes;
filtering the template to display filtered media stations satisfying the one or more filter attributes;
accepting user input selecting a subset of the filtered media stations;
tagging the subset of the filtered media stations to generate tagged media stations;
displaying a map child window on the display device of the computer system concurrently with the template, the map child window including a geographic map having a plurality of markers corresponding to the physical locations of the tagged media stations;
receiving user input selecting a user-specified region on the map child window; and
automatically highlighting, in the template, media stations displayed in the template that also correspond to markers displayed within the user-specified region.

2. The method of claim 1, further sorting the plurality of entries in the template to be displayed according to user selection of one or more of the attributes.

3. The method of claim 1, wherein the filtered media stations are filtered based on a filter attribute that is different from a user-specified map category.

4. The method of claim 1 wherein the filter attributes include multiple types radio station formats.

5. The method of claim 1, further comprising:
automatically highlighting entries in the template responsive to user selection of corresponding individual markers shown on the geographic map.

6. The method of claim 1, further comprising:
displaying a chart which compares the tagged media stations in the subset of filtered media stations according to a selected attribute; and
displaying a trend graph which shows attribute value trends for the tagged media stations in the subset of filtered media stations over time.

7. The method of claim 1, further comprising:
automatically filtering markers on the geographic map responsive to user selection of corresponding tagged media stations in the subset of filtered media stations.

8. A computer system, comprising:
at least one processor;
a display device responsive to said at least one processor;
a memory device coupled to said at least one processor; and
program instructions residing in the memory device an executed by the at least one processor, the program instructions configured to implement a method including:
obtaining location information indicating physical locations of a plurality of media stations from a geographic information system (GIS) configured to serve location information associated with the plurality of media stations;
obtaining, from a second source, separate and unrelated to the GIS, information associated with content broadcast by the plurality of media stations;
displaying at least a portion of a template on a display device of a computer system, the template including:
a plurality of entries corresponding to particular media stations of the plurality of media stations, each entry in the template having associated therewith a unique station identifier identifying a media station;
multiple attribute fields indicating attributes of the media station, wherein the multiple attribute fields include:
location attributes associated with the location information; and
station attributes associated with the content broadcast by the plurality of media stations;
accepting a user selection of one or more filter attributes;
filtering the template to display filtered media stations satisfying the one or more filter attributes;
accepting user input selecting a subset of the filtered media stations;
tagging the subset of the filtered media stations to generate tagged media stations;
displaying a map child window on the display device of the computer system concurrently with the template, the map child window including a geographic map having a plurality of markers corresponding to the physical location of the tagged media stations;
receiving user input selecting a user-specified region on the map child window; and
automatically highlighting, in the template, media stations displayed in the template that also correspond to markers displayed within the user-specified region.

9. The computer system of claim 8, wherein the method implemented by the program instructions further includes:
sorting the plurality of entries in the template to be displayed according to user selection of one or more of the attributes.

10. The computer system of claim 8, wherein the filtered media stations are filtered based on a filter attribute that is different from a user-specified map category.

11. The computer system of claim 8, wherein the filter attributes include multiple types radio station formats.

12. The computer system of claim 8, wherein the method implemented by the program instructions further includes:
automatically highlighting entries in the template responsive to user selection of corresponding individual markers shown on the geographic map.

13. The computer system of claim 8, wherein the method implemented by the program instructions further includes:
displaying a chart which compares the tagged media stations in the subset of filtered media stations according to a selected attribute; and
displaying a trend graph which shows attribute value trends for the tagged media stations in the subset of filtered media stations over time.

14. The computer system of claim 8, wherein the method implemented by the program instructions further includes:
automatically filtering markers on the geographic map responsive to user selection of corresponding tagged media stations in the subset of filtered media stations.

15. A graphical user interface (GUI) comprising:
a first display area configured to display at least a portion of a template on a display device of a computer system, the template including:
a plurality of entries corresponding to a plurality of media stations, each entry in the template having associated therewith a unique station identifier identifying a media station;
multiple attribute fields indicating attributes of the media station, wherein the multiple attribute fields include:
location attributes; and
station attributes associated with content broadcast by the plurality of media stations;
the first display area further configured to:
accept a user selection of one or more filter attributes;
display filtered media stations satisfying the one or more filter attributes;
accept user input selecting a subset of the filtered media stations;
tag the subset of the filtered media stations to generate tagged media stations;
a second display area configured to display a map child window on the display device of the computer system concurrently with the template, the map child window including a geographic map having a plurality of markers corresponding to physical locations of the tagged media stations;
the second display area further configured to accept user input selecting a user-specified region on the map child window; and
in response to the second display area accepting the user input, the first display area further configured to automatically highlight, in the template, media stations displayed in the template that also correspond to markers displayed within the user-specified region.

16. The graphical user interface (GUI) of claim 15, wherein the first display area is further configured to:
display the plurality of entries in the template sorted according to user selection of the one or more of attributes.

17. The graphical user interface (GUI) of claim 15, wherein the filtered media stations are filtered based on a filter attribute that is different from a user-specified map category.

18. The graphical user interface (GUI) of claim 15 wherein the filter attributes include multiple types radio station formats.

19. The graphical user interface (GUI) of claim 15, wherein the first display area is further configured to:
automatically highlight entries in the template responsive to user selection of corresponding individual markers shown on the geographic map.

20. The graphical user interface (GUI) of claim 15, further including:
a third display area configured to display a chart which compares the tagged media stations in the subset of filtered media stations according to a selected attribute; and
a fourth display area configured to display a trend graph which shows attribute value trends for the tagged media stations in the subset of filtered media stations over time.
